(19) United States
(12) Patent Application Publication
(10) Pub. No.: US 2026/0105094 A1
(43) Pub. Date: Apr. 16, 2026

(54) SYSTEMS AND METHODS FOR MITIGATING POSITIONAL BIAS IN LANGUAGE MODELS

(71) Applicant: Salesforce, Inc., San Francisco, CA (US)

(72) Inventors: Shafiq Rayhan Joty, San Jose, CA (US); David Wan, Palo Alto, CA (US)

(21) Appl. No.: 19/228,136

(22) Filed: Jun. 4, 2025

Related U.S. Application Data
(60) Provisional application No. 63/707,093, filed on Oct. 14, 2024.

(51) Int. Cl. G06F 16/34; G06F 16/953; G06F 40/205

(52) U.S. Cl. CPC G06F 16/345; G06F 16/953; G06F 40/205

(57) ABSTRACT

Embodiments described herein provide a method for configuring an artificial intelligence (AI) agent to respond to user queries based on retrieved contextual documents. The method includes receiving a user query comprising a natural language description of a topic and retrieving a plurality of documents related to the topic. A summary is generated from the concatenated documents, and each sentence of the summary is attributed to a document. The faithfulness of each sentence to its attributed document is determined, and a set of faithfulness values is computed for the documents. The document with the highest faithfulness value is selected and displayed to the user.

The instant application is a nonprovisional of and claims priority under 35 U.S.C. 119 to U.S. provisional application no. 63/707,093, filed October 14, 2024, which is hereby expressly incorporated by reference herein in its entirety.

### TECHNICAL FIELD

The embodiments relate generally to machine learning systems for natural language processing, and more specifically to systems and methods for mitigating positional bias in language models.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, Large Language Models (LLMs) used by AI agents often exhibit positional bias in long-context settings, under-attending to information in the middle of inputs.

### BRIEF DESCRIPTION OF THE DRAWINGS

FIG. 1 is a simplified diagram illustrating a LLM based AI agent interface according to some embodiments.

FIG. 2 is a simplified diagram illustrating a LLM based AI agent framework according to some embodiments.

FIG. 3A is a simplified diagram illustrating a computing device implementing the LLM based AI agent framework described in FIGS. 1-2, according to some embodiments.

FIG. 3B is a simplified diagram illustrating a neural network structure, according to some embodiments.

FIG. 4 is a simplified block diagram of a networked system suitable for implementing the LLM based AI agent framework described in FIGS. 1-3B and other embodiments described herein.

FIG. 5 is an example logic flow diagram illustrating a method of configuring an AI agent to respond to a user query based on the framework shown in FIGS. 1-4, according to some embodiments.

FIG. 6 illustrates exemplary faithfulness values for retrieved documents for summaries generated using different models.

FIGS. 7-10 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

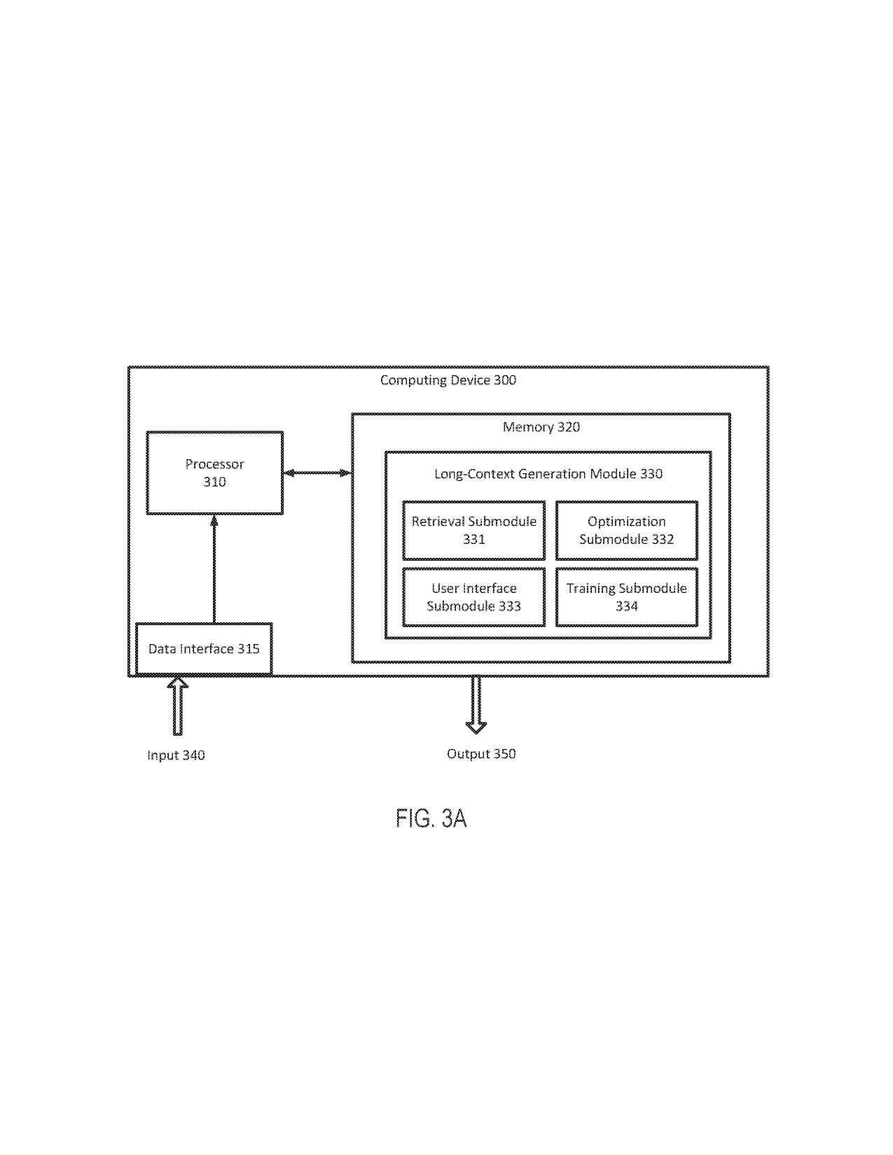

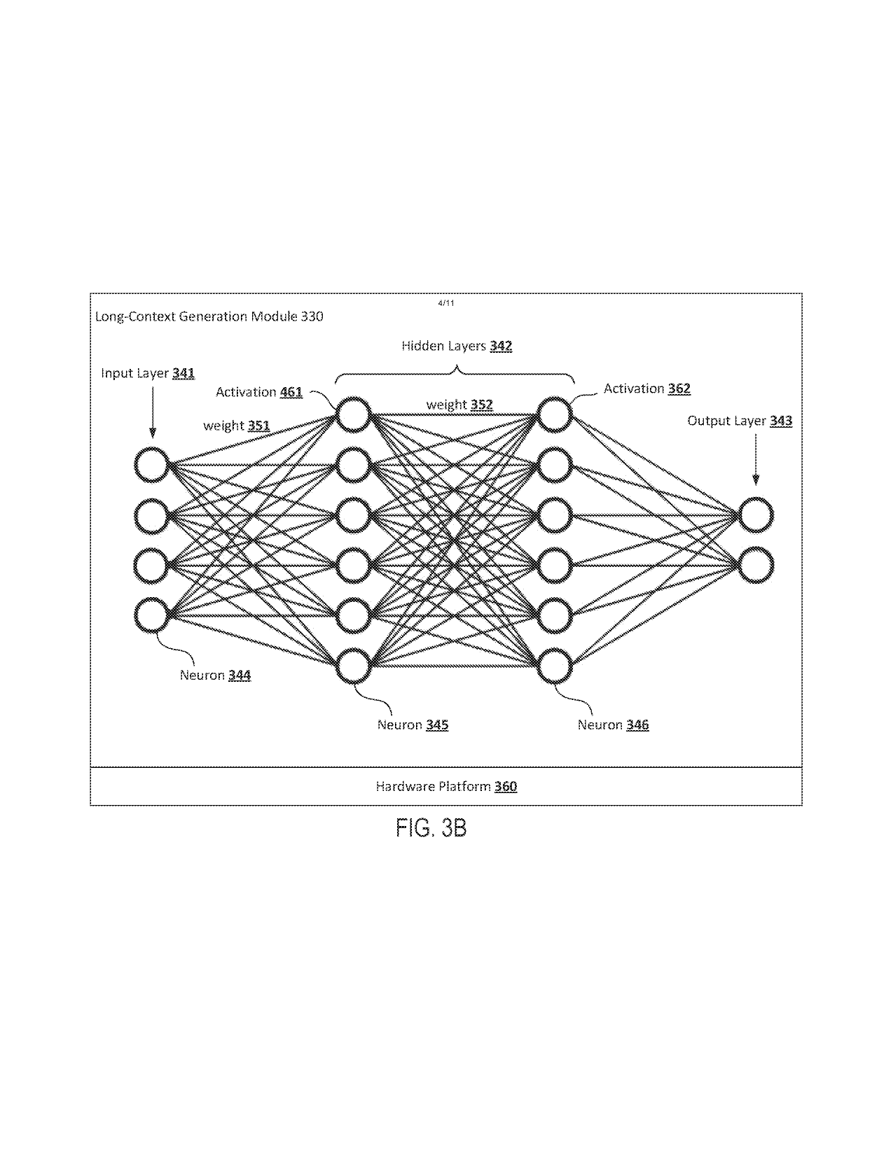

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Large Language Models (LLMs) used by AI agents often exhibit positional bias in long-context settings, under-attending to information in the middle of inputs. In view of the need for improved methods of handling large input contexts to language models, embodiments described herein include systems and methods for mitigating positional bias in language models. Positional bias in large language models (LLMs) often results in under-attention to information located in the middle of input documents, leading to hallucinations and inaccuracies in the generated responses to prompts. Embodiments herein include a method to evaluate and mitigate this bias by determining faithfulness values, which represent the percentage of sentences in a summary that are accurately attributed to their respective source documents. Faithfulness values may be used in comparing the relative strength of summaries, identifying which retrieved document a summary is most faithful to, selecting an LLM for a task, displaying relevant information to a user, etc.

The system begins by receiving a user query in natural language, which describes a topic of interest. The user query may be, for example, a request to generate a summary of documents related to a particular topic. The system retrieves a plurality of documents related to the topic. Using a neural network-based language model, the system generates a response from these documents. Each sentence of the response is attributed to one of the retrieved documents. Each sentence in the response is evaluated to determine its faithfulness to the source document it is attributed to. This evaluation is based on a metric that assesses whether the sentence accurately reflects the content of the document.

Faithfulness values may be computed for each document, representing the percentage of sentences in the response that are faithful to the respective document to which each sentence is attributed. These values may then used in various ways to improve the overall quality and reliability of the generated responses. For instance, the system can display the faithfulness values to the user, allowing them to understand the reliability of the response. Additionally, the system can select the most faithful document based on these values, ensuring that the most accurate information is highlighted.

To further enhance response generation, the system can generate multiple responses by varying the order of the documents. This helps in identifying the optimal document order that maximizes the faithfulness of the generated summary. By addressing the positional bias, the system ensures that the generated responses are more accurate and reliable, thereby improving the overall performance.

Embodiments described herein provide a number of benefits. For example, by generating responses using different document orders and selecting the best response, the technical limitation of positional bias may be mitigated. In another example, by determining faithfulness values for each sentence in a response, the system ensures that the generated responses are more accurate and reliable, thereby reducing the occurrence of hallucinations and inaccuracies. This improves the overall trustworthiness of AI-generated outputs. In another example, by displaying faithfulness values to users, the system enhances user understanding of the reliability of the summaries, which can be particularly beneficial in critical applications such as healthcare document summarization. Additionally, by selecting documents based on their faithfulness values, the system ensures that the most accurate and relevant information is highlighted, improving the quality of the summaries. Furthermore, generating multiple summaries with different document orders helps identify the optimal document order that maximizes faithfulness, thereby addressing the positional bias inherent in large language models. This iterative approach not only improves the accuracy of the responses but also enhances the model's ability to handle long-context inputs effectively.

Therefore, with improved performance on mitigating positional bias, AI agent technology becomes significantly more accurate and reliable. For example, in the technical field of software debugging or program analysis, a bug may occur at the end of a long function, but positional bias may lead the AI agent to incorrectly focus on issues introduced earlier. By mitigating positional bias, the AI agent can more evenly weigh information across the entire input, allowing it to correctly identify that the critical error lies in the final lines of code, leading to faster, more precise debugging and better overall system performance.

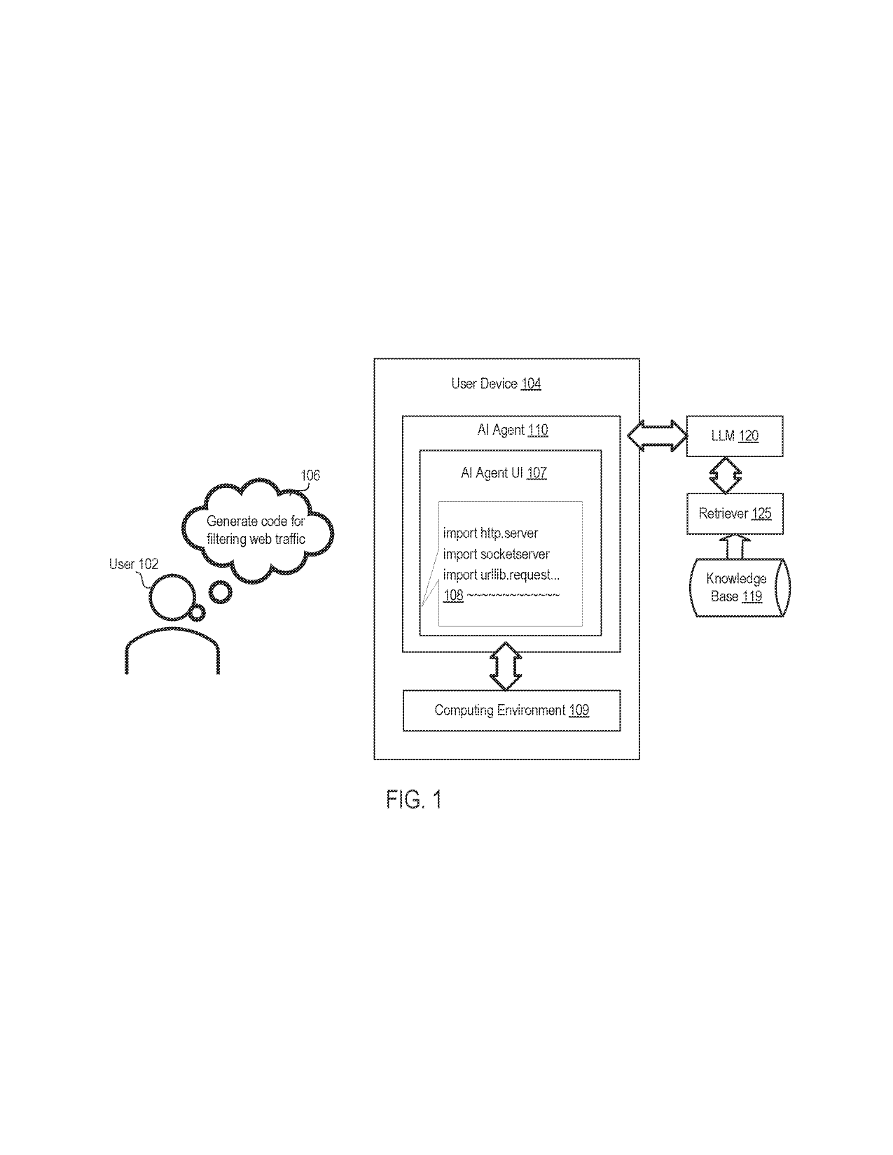

FIG. 1 is a simplified diagram illustrating a LLM based AI agent interface according to some embodiments. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “generate code for filtering web traffic” 106.

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 3B.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to “generate code for filtering web traffic,” the LLM 120 may output a code script 108 to execute on the computing environment 109 (such as a web browser) on the user device 104 to filter web traffic, and/or interface with APIs of other applications to filter web traffic, and/or the like. In this way, the LLM-based AI agent may facilitate end-to-end workflow to automate the task request 106.

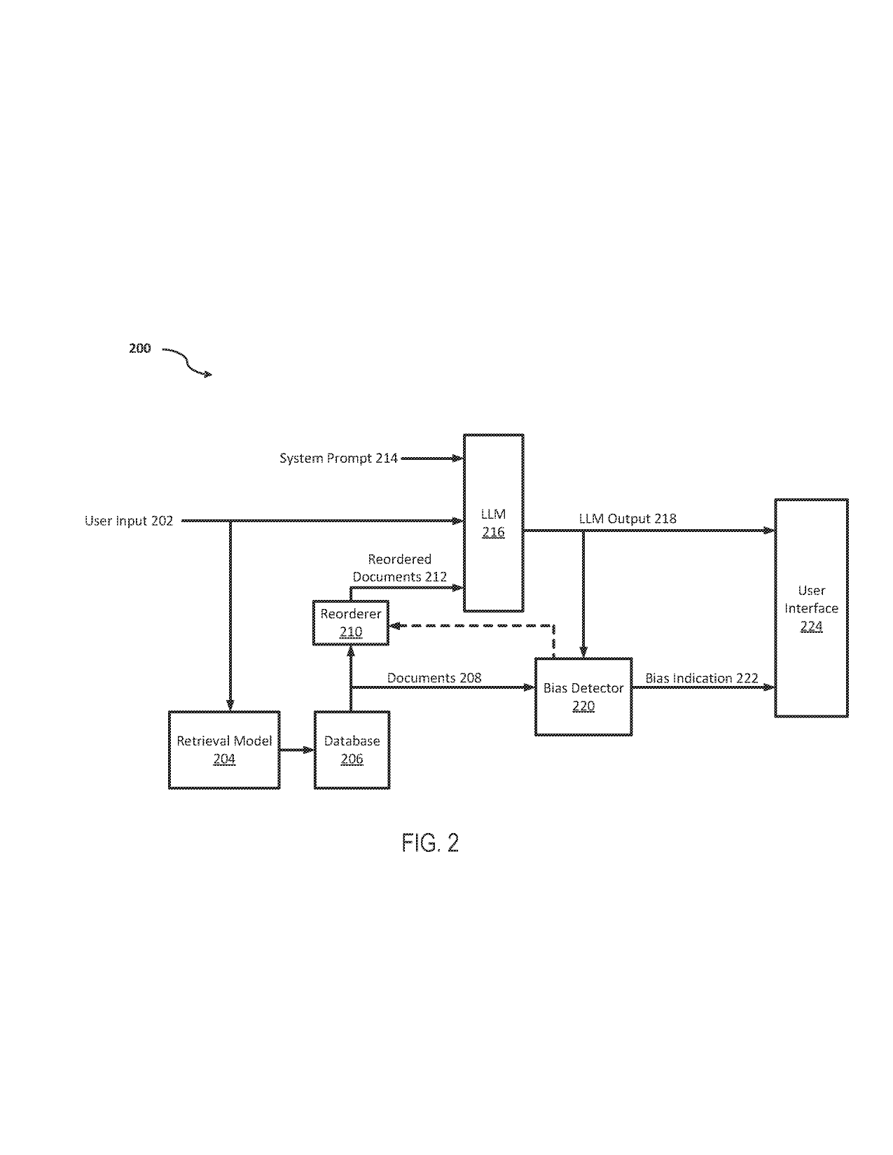

In some embodiments, AI agent 110 may retrieve one or more documents (e.g., from an internet search, a database, etc.) relevant to query 106. Retrieved documents may be concatenated together with the system prompt and the user query 106 to form the input to an LLM. However, a long context that includes multiple documents may result in hallucinations or other errors related to a positional bias of the LLM. For example, for a user query of “generate code for filtering web traffic,” retrieved documents could include a knowledge base article on the subject, a knowledge base article related to writing code that is not susceptible to hacks, and a code sample, and these documents may be concatenated in that order. For an LLM generating the code in response to the query 106, the middle document (in this example the knowledge base article related to writing code that is not susceptible to hacks) may receive less attention than the first and last documents, resulting in generated code that does not abide by what is described in the middle document. Embodiments described herein provide mitigations for positional bias such as this, as further described in FIG. 2 below.

FIG. 2 is a simplified diagram illustrating a LLM based AI agent framework according to some embodiments. User input 202 is a natural language description of a topic or query, received via a communication interface. For example, user input 202 may be a request for code generation as in the exemplary user task request 106. User input 202 may also be a request to provide a summary based on multiple input documents. User input 202 is provided to the retrieval model 204. The retrieval model 204 interprets the user input 202 and formulates a search query to retrieve a plurality of documents from the database 206. The database 206 serves as a repository of potentially relevant documents, which may include parsed internet content or other structured and unstructured data sources. In some embodiments, database 206 includes internet content, and retrieval model 204 performs a search of the internet and parses the found content as the retrieved information. In some embodiments, searching the internet may comprise searching a web indexing system.

Upon retrieval, the documents 208 are identified as the set of contextual documents most relevant to the user input 202. In some embodiments, these documents 208 are concatenated in a specific order with the user input 202 and a system prompt 214. The system prompt 214 provides high-level instructions or behavioral guidelines to the LLM 216, such as specifying the desired response format, instructing the LLM to provide citations, or guiding the style and reasoning of the output. The concatenated input comprising the system prompt 214, user input 202, and documents 208 is then provided to the LLM 216 for processing.

In some embodiments, documents 208 are not retrieved, but rather provided as inputs by the user together with user input 202. For example, a user may provide a number of documents, and user input 202 may be a request to summarize the provided documents. In some embodiments, documents 208 are not input as distinct documents, but rather the input to the LLM may include a user input 202 and/or system prompt 214 that is long, and the prompt is chunked into discrete portions for the purpose of determining positional bias of the long-context input.

In some embodiments, before the documents 208 are input to the LLM 216 (or as part of a separate iteration), they are first processed by a reorderer 210. The reorderer 210 is responsible for rearranging the order of the documents 208 to form reordered documents 212. This reordering may be based on prior knowledge, heuristics, or dynamically in response to feedback from a bias detector 220. The reordered documents 212, along with the system prompt 214 and user input 202, are then concatenated and provided to the LLM 216. This mechanism allows the system to utilize different document orders to address and reduce positional bias in the LLM’s response.

LLM 216, which may be a neural network-based language model, processes the concatenated input and generates an output 218. This output 218 may take the form of a summary, generated code, or any other multi-sentence response, where each sentence may be attributed to one of the input documents.

Following generation, the LLM output 218 is analyzed by the bias detector 220. The bias detector 220 determines, for each sentence in the LLM output 218, the specific document of the plurality of documents 208 (or reordered documents 212) to which the sentence is attributed, based on a first metric (such as semantic similarity or attribution scoring). In some embodiments, semantic similarity is determined by encoding all or portions of each document, separately encoding the sentence being considered, and computing a distance between the encodings (e.g., Euclidean distance or cosine similarity) with the closest distance being the document to which the sentence is attributed. In some embodiments, the attribution is performed by prompting a second LLM for an attribution together with the documents and the generated sentence. The second LLM may be prompted to provide a binary attribution (e.g., yes/no) or a value representing the likelihood of attribution. The bias detector 220 further evaluates, using a second metric, whether each sentence is faithful to the document to which it is attributed. In some embodiments, the first metric provides a binary attribution, while the second metric provides a value (e.g., a 0-1 probability) and the value of the second metric is used to determine faithfulness based on exceeding a threshold value. In some embodiments, the first and/or second metric are determined via a specially trained attribution model, which may be trained for example based on synthetic training data from a full LLM prompted for attribution. For example, the Minicheck model as described in Tang et al., MiniCheck: Efficient Fact-Checking of LLMs on Grounding Documents, arXiv:2404.10774, 2024.

In some embodiments, the second metric is the same as the first metric. For example, a first metric may be used to determine for a sentence of output 218 separate probability values that the sentence is associated with each of the documents 208. The document associated with the highest probability may be identified via this metric as the document to which the sentence is attributed. Whether or not the sentence is considered faithful to that attributed document may be determined by the same metric exceeding a predetermined threshold. In this way with the same (or different) metric, a sentence may be attributed to a document even if considered not faithful to that document, by merit of it being more likely attributable to that document than the other documents.

In some embodiments, bias detector 220 computes of a set of faithfulness values corresponding to the plurality of documents, where each value represents the percentage of sentences attributed to a respective document that are faithful to that document. The bias detector 220 may also compute a positional bias metric based on differences between the faithfulness values, quantifying the extent to which the LLM output 218 is biased toward certain document positions (e.g., beginning, middle, or end). In some embodiments, there is a faithfulness value associated with each document, but a single positional bias value associated with a generated output 218 which represents the overall bias. For example, the positional bias value may be determined by computing a spread, variance, or standard deviation of the faithfulness values.

Based on the analysis by the bias detector 220, several actions may be taken. In some embodiments, if the positional bias metric surpasses a predefined threshold, the reorderer 210 is signaled to generate a new order of the documents 208, resulting in a new set of reordered documents 212. The LLM 216 then generates a second summary or output 218 from this new order, and the process of faithfulness evaluation and positional bias detection is repeated. This iterative process may continue, with the system comparing sets of faithfulness values and positional bias metrics across different document orders, until the positional bias is reduced below a predetermined threshold or the most faithful document order is identified. In some embodiments, the selected document for display or further processing is chosen based on having the highest average faithfulness value between multiple sets of faithfulness values computed from different document orders.

In some embodiments, the bias indication 222 (e.g., the individual faithfulness values and/or the positional bias value) generated by the bias detector 220 is sent directly to the user interface 224 along with the LLM output 218. The bias indication 222 may include the set of faithfulness values, the positional bias metric, or an explicit identification of the document to which the output 218 is most faithful. The user interface 224 then displays the LLM output 218 and, where applicable, the bias indication 222 to the user. This may involve visualizing the faithfulness scores for each document, highlighting the document most closely aligned with the LLM output 218, or providing other transparency features to help the user assess the reliability and grounding of the response.

Throughout this process, the user interface 224 serves as the primary point of interaction, presenting the LLM output 218 and any associated bias indication 222 in a clear and informative manner. For example, the user interface 224 may allow the user to view the response alongside a breakdown of faithfulness values for each document, or to access the specific document that most influenced the response. This framework ensures that the AI agent not only provides accurate and contextually relevant answers, but also offers transparency and accountability regarding the sources and faithfulness of its responses, thereby enhancing user trust and the overall quality of the interaction.

To mitigate positional bias, the framework of FIG. 2 may support three distinct methods: Focus Prompt Method, Hierarchical Merging Method, and Incremental Updating Method.

For the Focus Prompt Method, the system prompt 214 can be dynamically augmented with explicit instructions directing the LLM 216 to focus on specific sections of the input documents 208. For example, the prompt may include phrases such as "Pay special attention to the top documents," "focus on the documents in the middle," or "focus on the bottom documents." This focus prompt is concatenated with the user query 202 and reordered documents 212 before being input to the LLM 216. By guiding the model’s attention to particular document positions, this method counteracts the natural tendency of LLMs to overemphasize the beginning or end of long contexts and to improve faithfulness for under-attended sections. In some embodiments, the system generates a first output 218, determines a bias via bias detector 220, and instead of (or in addition to) reordering documents, the focus prompt may be updated to mitigate the perceived bias in response to the bias detected by bias detector 220. For example, if 5 documents were provided, and the respective faithfulness values were determined to be [90%, 88%, 97%, 85%, 25%], then the focus prompt may be updated to say something like “pay particular attention to the last document” and the output 218 may be regenerated using that prompt as part of system prompt 214 to improve the bias. This process may be iterated until the positional bias is reduced a desired amount or after a maximum number of iterations.

For the Hierarchical Merging Method, the system may generate individual summaries for each document or document chunk within the set of documents 208. These intermediate summaries are then recursively merged: the LLM 216 is prompted to combine pairs (or groups) of summaries into higher-level summaries, iteratively, until a single comprehensive summary is produced. The hierarchical merging process is orchestrated by the system, which manages the sequence of merge operations and ensures that the final summary integrates content from all documents. This method is designed to ensure that information from each document is explicitly considered, thereby reducing the risk that middle or less prominent documents are neglected due to positional bias.

For the Incremental Updating Method, it may be implemented by sequentially presenting the LLM 216 with one document at a time, along with the current working summary. The process begins with the first document and an empty or initial summary. The LLM 216 generates a summary for the first document. Then, for each subsequent document, the LLM 216 receives the next document and the current summary, and is prompted to update the summary to incorporate new information. This process continues until all documents have been processed and the final summary is produced. The incremental updating method, which may be managed by the reorderer 210 and the system prompt 214, encourages the LLM 216 to iteratively refine its output, reducing positional by ensuring each document is considered in turn. The different mitigation methods as described herein may be used individually or in any combination.

### Computer and Network Environment

FIG. 3A is a simplified diagram illustrating a computing device implementing the LLM based AI agent framework described in FIGS. 1-2, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for long-context generation module 330 that may be used to implement and/or emulate the systems and models, and/or to implement any of the methods described further herein. long-context generation module 330 may receive input 340 such as an input training data (e.g., user prompts) via the data interface 315 and generate an output 350 which may be a summary or other output as described herein.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as a user prompt, from a user via the user interface.

In some embodiments, the long-context generation module 330 is configured to generate outputs with mitigated positional bias and/or identification of document(s) or faithfulness values based on a determined positional bias as described herein. The long-context generation module 330 may further include retrieval submodule 331 (e.g., similar to retrieval model in FIG. 2) configured to perform retrieval tasks as described herein. The long-context generation module 330 may further include optimization submodule 332 configured to optimize outputs by mitigating positional bias as described herein. The long-context generation module 330 may further include user interface submodule 333 configured to display outputs, faithfulness values, positional bias values, selected documents, etc. as described herein. The long-context generation module 330 may further include training submodule 334 configured to train the model which may include training an LLM, a retrieval model, etc.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the long-context generation module 330 described in FIG. 3A, according to some embodiments. In some embodiments, the long-context generation module 330 and/or one or more of its submodules 331-334 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as a user input prompt. The number of nodes (neurons) in the input layer 341 may be determined by the dimensionality of the input data (e.g., the length of a vector of the input). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the long-context generation module 330 receives an input 340 of a user input prompt and transforms the input into an output 350 of a response. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the long-context generation module 330 and/or one or more of its submodules 331-334 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be a transformer model, and/or the like.

In one embodiment, the long-context generation module 330 and its submodules 331-334 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the long-context generation module 330 and its submodules 331-334 may be implemented by hardware, software and/or a combination thereof. For example, the long-context generation module 330 and its submodules 331-334 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the long-context generation module 330 and its submodules 331-334 and/or any other neural network models onto hardware platform 360, the neural network based modules 330 and its submodules 331-334 may be optimized for deployment by converting it to a suitable format, such as ONNX or TensorRT, to improve performance and compatibility. Next, depending on the size and workload requirements for modules 330 and its submodules 331-334, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the long-context generation module 330 and its submodules 331-334 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the long-context generation module 330 and its submodules 331-334 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the long-context generation module 330 and its submodules 331-334 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the long-context generation module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based long-context generation module 330 and one or more of its submodules 331-334 may be trained by iteratively updating the underlying parameters (e.g., weights 351, 352, etc., bias parameters and/or coefficients in the activation functions 361, 362 associated with neurons) of the neural network based on a loss. For example, during forward propagation, the training data such as a user input prompt are fed into the neural network. The data flows through the network's layers 341, 342, with each layer performing computations based on its weights, biases, and activation functions until the output layer 343 produces the network's output 350. In some embodiments, output layer 343 produces an intermediate output on which the network’s output 350 is based.

The output generated by the output layer 343 is compared to the expected output (e.g., a “ground-truth” such as the corresponding output) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based long-context generation module 330 and one or more of its submodules 331-334 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning – in other words, backward propagation and forward propagation may occur for both “training” and “inference” stages of the neural network mode.

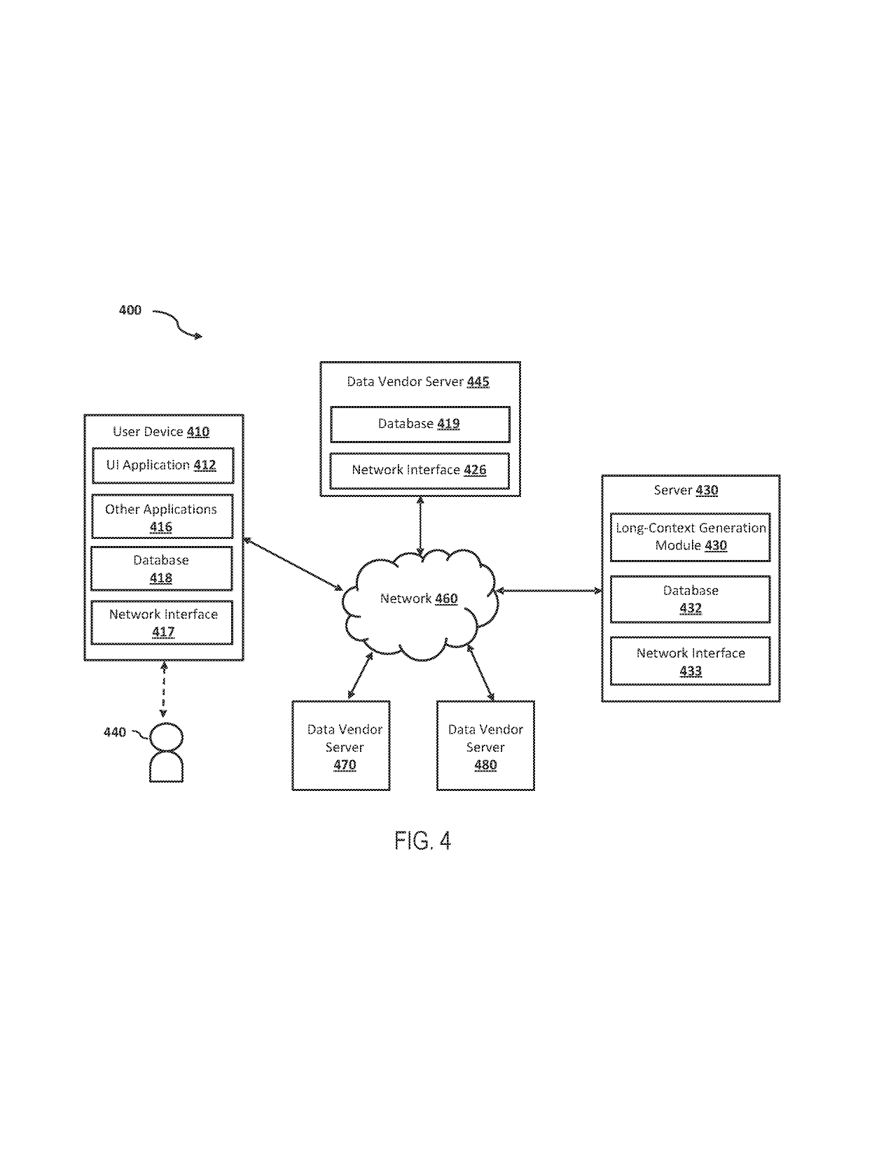

In some embodiments, long-context generation module 330 and its submodules 331-334 may be housed at a centralized server (e.g., computing device 300) or one or more distributed servers. For example, one or more of long-context generation module 330 and its submodules 331-334 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen user prompts and retrieved documents.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agents, especially for long input contexts.

FIG. 4 is a simplified block diagram of a networked system 400 suitable for implementing the LLM based AI agent framework described in FIGS. 1-3B and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a response from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the long-context generation module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which long-context generation module 330 may generate a response via the process described in FIGS. 1-3B. The long-context generation module 330 may thus cause a display of responses and bias indications or selected documents at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view responses.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including prompts and responses to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the long-context generation module 330 and its submodules described in FIG. 3A. In some implementations, long-context generation module 330 may receive data from database 419 at the data vendor server 445 via the network 460 to generate responses. The generated responses may also be sent to the user device 410 for review by the user 440 via the network 460.

In one embodiment, an AI agent implementing the long-context generation module 330 and its submodules described in FIG. 3A may be built based on an LLM as described in FIG. 3B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the long-context generation module 330 and its submodules described in FIG. 3A may be implemented as a cloud-based AI agent which may be accessed by user device 410 via a chatbot application, a web application, customer support or SaaS applications. In another implementation, a client-side AI agent component may be delivered from the server 430 to user device 410 for local installation such that the client-side AI agent may be installed and runs directly on the user’s device. Such local AI agent on the user device 410 may be available offline to adapt to privacy-sensitive applications. In another implementation, the AI agent implementing the long-context generation module 330 and its submodules described in FIG. 3A may adopt a hybrid cloud and client-based structure to balance computing speed, cost and privacy. For example, a local AI agent may handle basic AI queries locally, but complex queries may be sent to server 430 to process.

The database 432 may be stored in a transitory and/or non-transitory memory of the server 430. In one implementation, the database 432 may store data obtained from the data vendor server 445. In one implementation, the database 432 may store parameters of the long-context generation module 330. In one implementation, the database 432 may store previously generated outputs, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

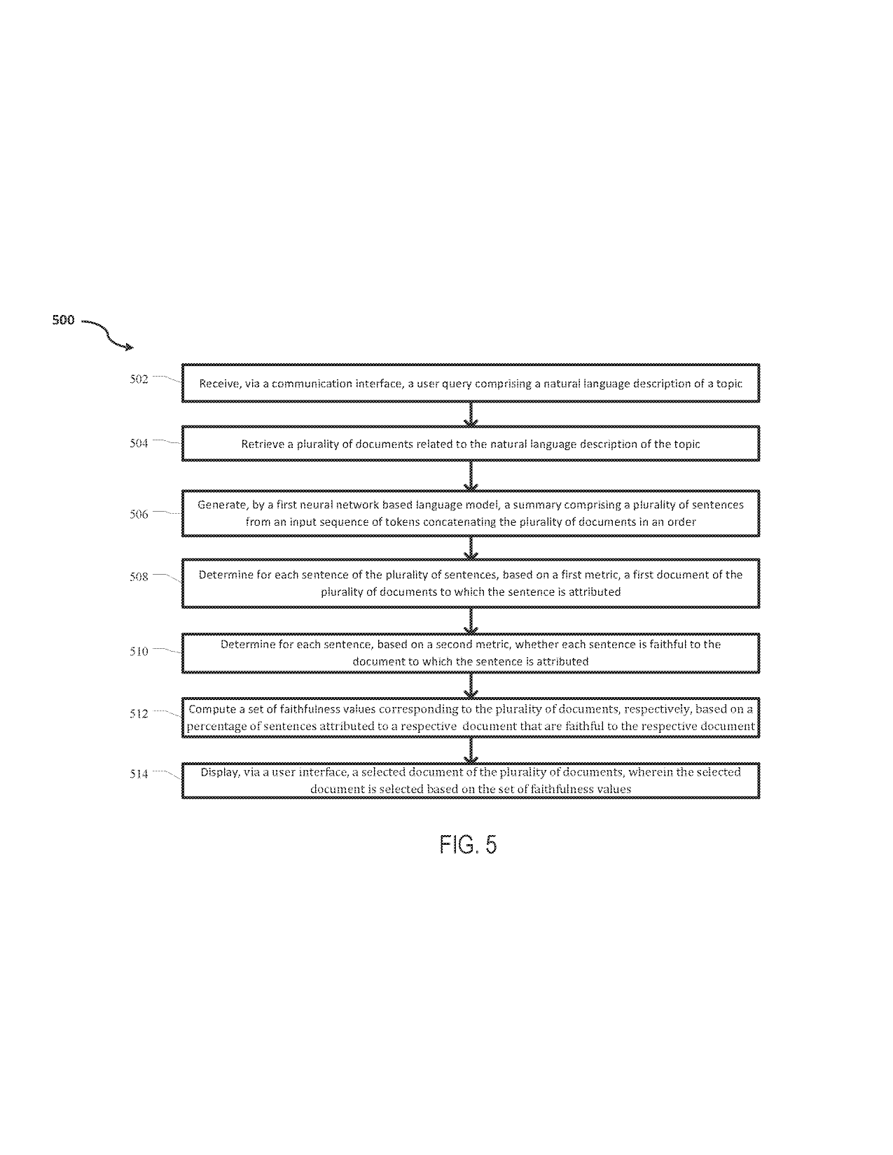

FIG. 5 is an example logic flow diagram illustrating a method of configuring an AI agent to respond to a user query based on the framework shown in FIGS. 1-4, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the long-context generation module 330 (e.g., FIGS. 3A and 4) that generates outputs based on inputs with long contexts (e.g., multiple retrieved documents) while mitigating and/or presenting positional bias.

In some embodiments, method 500 is performed by a system such as computing device 300, user device 410, server 430, or another device or combination of devices. Inputs (e.g., user input prompts) may be received via a data interface such as data interface 315, network interface 417, network interface 433, or via a data interface that is integrated with a device. For example UI Application 412 may receive user inputs via a text input interface (e.g., keyboard), audio input (e.g., microphone), video interface (e.g., camera), or other interface for receiving user inputs (e.g., a mouse or touch display).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, the system receives, via a communication interface, a user query comprising a natural language description of a topic. In some embodiments, the user query is a request to provide a summary, a request for code generation, a request for a medical diagnostic, etc. In some embodiments, the system may also preprocess the query (e.g., to remove any irrelevant information or noise).

At step 504, the system retrieves a plurality of documents related to the natural language description of the topic. In some embodiments, the retrieving includes parsing internet content based on a search query. The system may use various search algorithms and databases to find documents that are most relevant to the user's query. In some embodiments, the retrieved documents are ranked based on their relevance to the query. In some embodiments, the retrieved documents are provided by the user via the user interface.

At step 506, the system generates, by a first neural network based language model, a summary comprising a plurality of sentences from an input sequence of tokens concatenating the plurality of documents in an order. In some embodiments, the input sequence of tokens also includes a concatenation of the user input and/or a system prompt.

At step 508, the system determines for each sentence of the plurality of sentences, based on a first metric, a first document of the plurality of documents to which the sentence is attributed. In some embodiments, the first metric may involve evaluating the semantic similarity between the sentence and the content of each document. In some embodiments, the first metric may be a binary attribution indicated via an LLM.

At step 510, the system determines for each sentence, based on a second metric, whether each sentence is faithful to the document to which the sentence is attributed. In some embodiments, the second metric may involve checking for factual consistency and relevance of the sentence to the document. In some embodiments, the first metric is the same as the second metric. In some embodiments, attribution is determined based on which document received the highest value of the first metric, and the faithfulness is determined based on the first metric surpassing a predetermined threshold for the attributed document.

At step 512, the system computes a set of faithfulness values corresponding to the plurality of documents, respectively, based on a percentage of sentences attributed to a respective document that are faithful to the respective document. In some embodiments, the faithfulness values are used to identify documents that are most reliable and relevant to the user's query.

At step 514, the system displays, via a user interface, a selected document of the plurality of documents, wherein the selected document is selected based on the set of faithfulness values. In some embodiments, the selected document is displayed in a manner that highlights the most relevant and faithful information. In some embodiments, the system may also provide additional context or explanations to help the user understand the displayed information.

In some embodiments, the system determines a positional bias metric based on differences between faithfulness values of the set of faithfulness values, wherein the selected document is selected further based on the positional bias metric. This helps in mitigating the effects of positional bias and ensures that the most relevant information is presented prominently.

In some embodiments, the system generates, by the first neural network based language model, a second summary comprising a second plurality of sentences from an input sequence of tokens concatenating the plurality of documents in a second order different from the order in response to the positional bias metric surpassing a threshold.

In some embodiments, the system generates, by a second neural network based language model, a second summary comprising a second plurality of sentences from the input sequence of tokens; determines a second positional bias metric associated with the second summary; and uses the second neural network based language model to perform a task based on a comparison of the positional bias metric to the second positional bias metric.

In some embodiments, the system generates, by the first neural network based language model, a second summary comprising a second plurality of sentences from a second input sequence of tokens concatenating the plurality of documents in a second order different from the order; and computes a second set of faithfulness values corresponding to the plurality of documents associated with the second summary, wherein the selected document is selected further based on a comparison of the set of faithfulness values to the second set of faithfulness values.

In some embodiments, the selected document is selected based on the selected document having a highest average faithfulness value between the set of faithfulness values and the second set of faithfulness values.

In some embodiments, method 500 is applicable in a variety of applications. For example, the user query may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like.

For example, In the field of medical diagnostics, method 500 can significantly enhance the accuracy and efficiency of diagnostic processes. By utilizing faithfulness values to evaluate the faithfulness of outputs to retrieved medical documents and research papers, the system can select the most accurate and relevant documents to present to healthcare professionals. For instance, when a doctor inputs a query regarding a specific medical condition, the system retrieves multiple documents related to the condition, calculates faithfulness values for each document, and displays the document with the highest faithfulness value. This ensures that the doctor receives the most reliable and pertinent information, thereby improving diagnostic accuracy and patient outcomes. Additionally, the system can generate multiple summaries of medical literature, concatenating documents in different orders to provide comprehensive insights, which can be particularly useful for complex cases requiring multi-faceted analysis.

In another example, method 500 can be applied to improve code generation and documentation processes. When a developer queries the system for code snippets or documentation related to a specific programming task, the system retrieves relevant documents, calculates faithfulness values, and presents the most reliable and contextually appropriate document. This can streamline the development process by reducing the time spent searching for accurate code examples and documentation. Furthermore, the system can generate multiple versions of code, concatenating documents in various orders to provide a holistic view. This can aid developers in producing high-quality code that is faithful to retrieved documents (e.g., retrieved sample code).

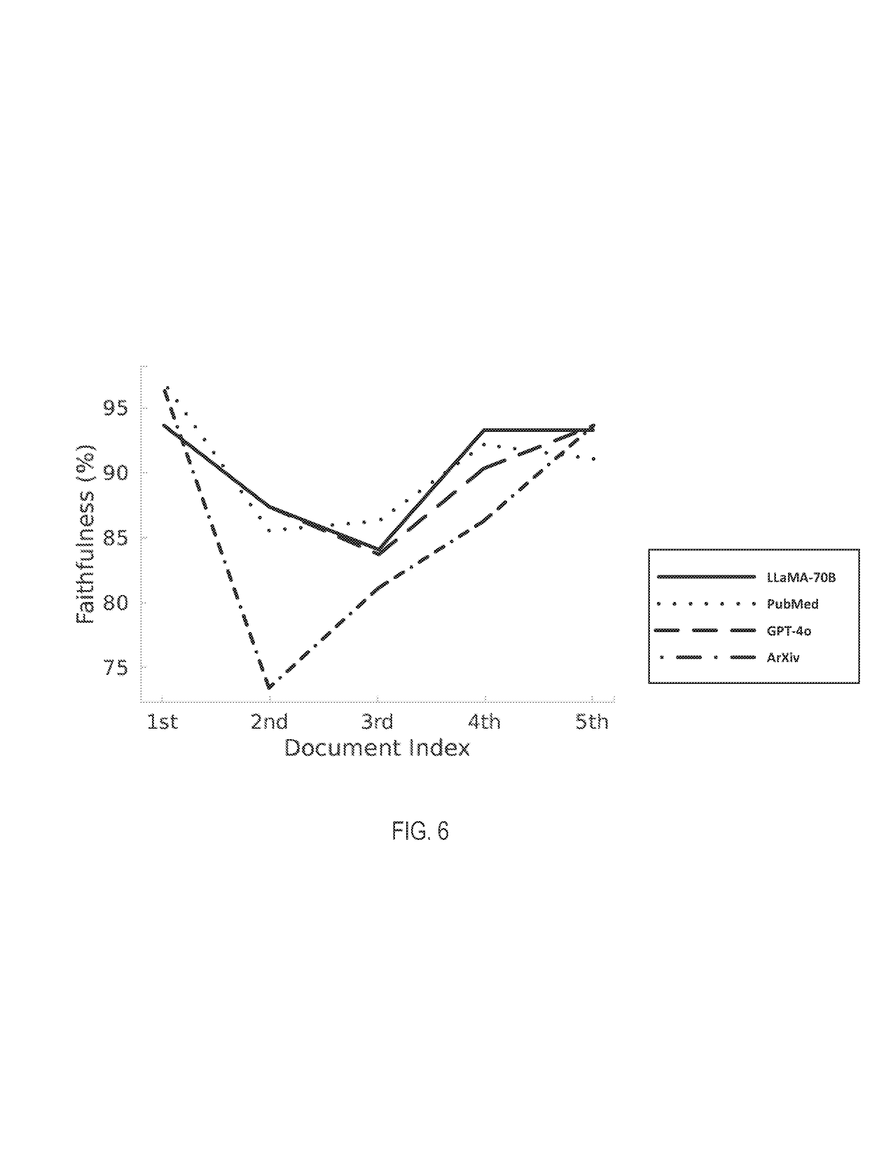

FIG. 6 illustrates exemplary faithfulness values for retrieved documents for summaries generated using different models.

### Example Results

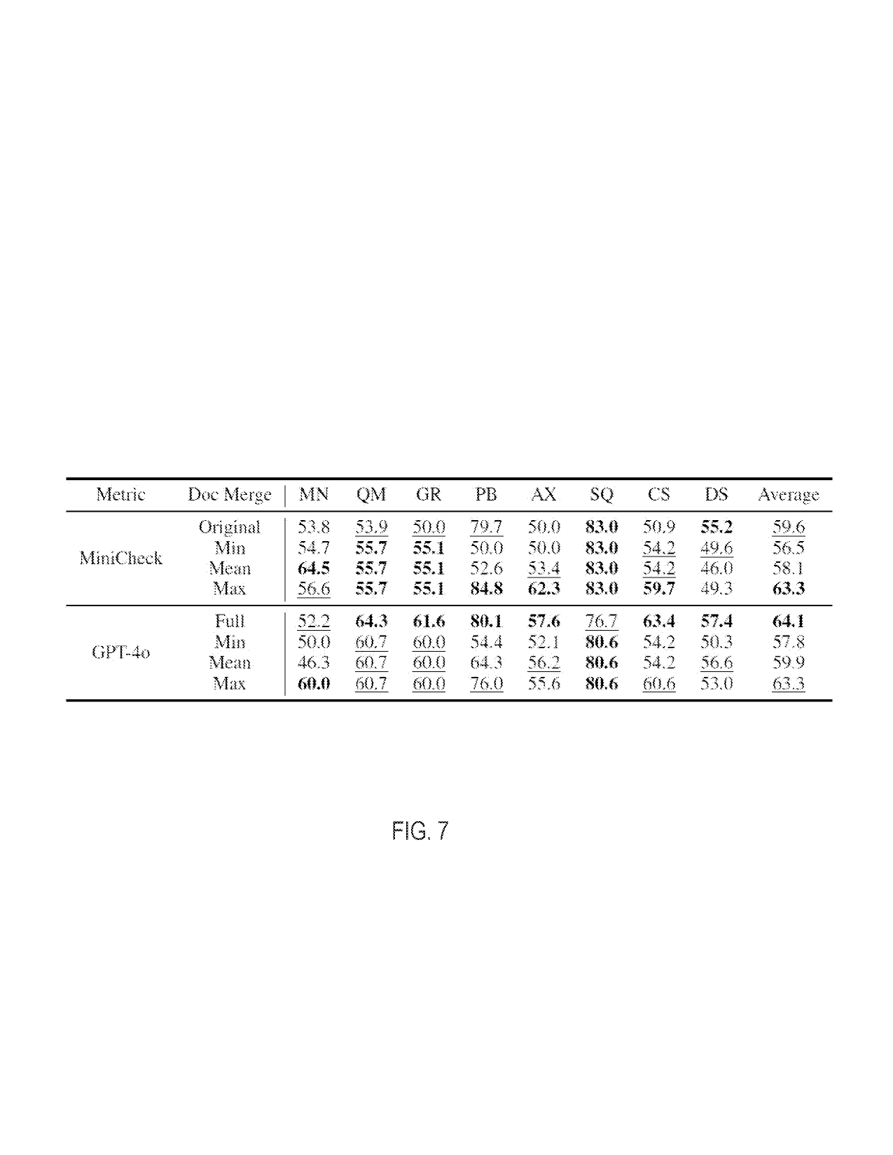

FIGS. 7-10 provide charts illustrating exemplary performance of embodiments described herein in evaluating and mitigating positional bias in long-form summarization tasks. The experiments involve comparisons across various models and metrics to assess the effectiveness of the proposed methods. The models used for comparison include GPT-4o (OpenAI, 2024), Llama-3.1-8B and Llama-3.1-70B (Dubey et al., The llama 3 herd of models, arXiv:2407.21783, 2024), and Mixtral-7×8B and Mixtral-8×22B (Jiang et al., Mixtral of experts, arXiv:2401.04088, 2024). The metrics used for evaluation include balanced accuracy (BACC) to calculate correlations with human judgments, and faithfulness scores to measure the accuracy of the generated summaries. The experiments also involve perturbation analysis to assess the sensitivity of the models to changes in document order and length. The results are presented in the following figures, each illustrating different aspects of the performance of the models.

FIG. 7 illustrates the balanced accuracy (BACC) of different chunking methods with GPT-4o. The results show that chunking the input into smaller chunks (1,024 tokens) leads to stronger performance than using the full context, while other chunk sizes result in worse correlations compared to the full context. This indicates that smaller context windows help the models, as LLMs still prefer shorter contexts. The fact that natural boundaries are only better than chunking with 4,096 tokens suggests that limiting based on size may be preferable to keeping the original documents as they are, since there is no control over how long each document is.

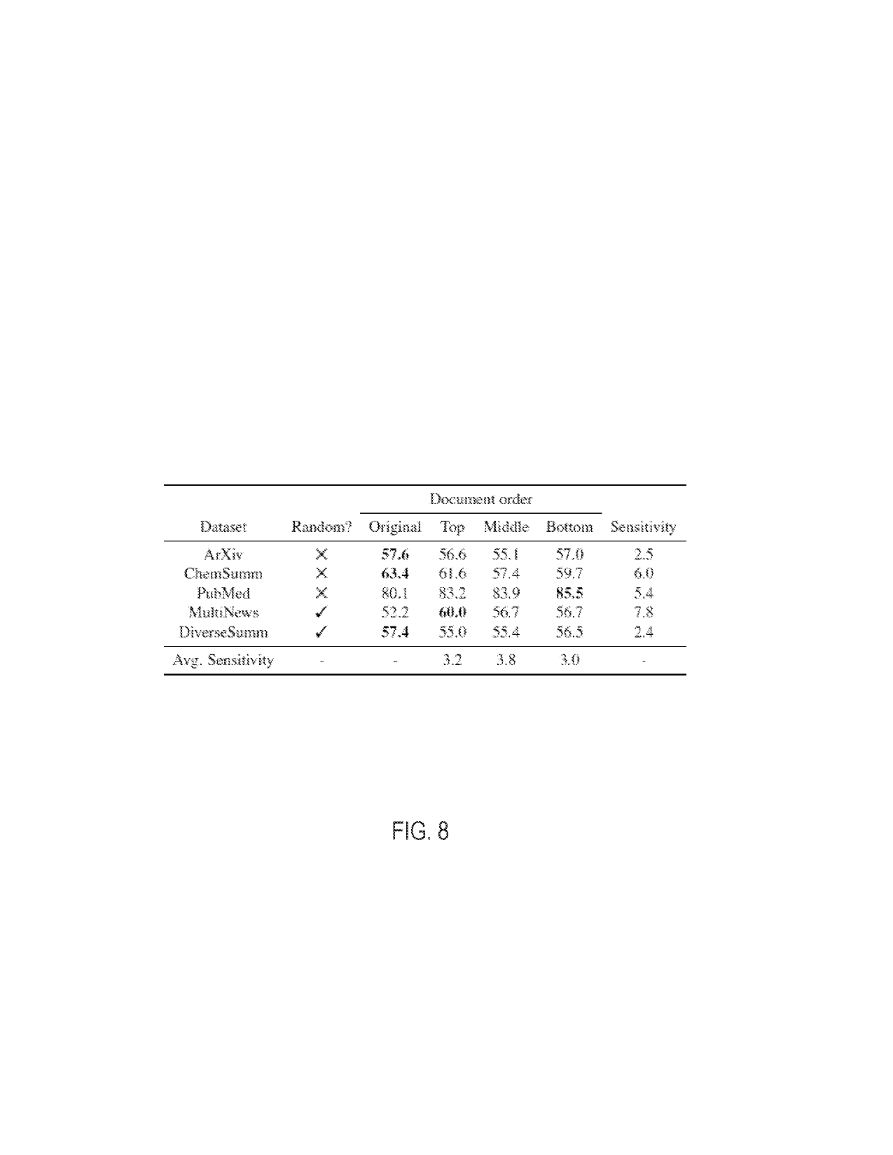

FIG. 8 illustrates the BACC using the GPT-4o-based faithfulness metric when the order of the documents is perturbed. The results show that the metric is sensitive to document order, with high sensitivity observed across each dataset, reaching a 7.8% difference for MultiNews. When comparing only the top, middle, and bottom orderings, no clear trend is observed across datasets; however, on average, the sensitivity is highest when the important document is placed in the middle. This indicates that the metric achieves the lowest BACC when the important document is in the middle, whereas placing it at the top results in the smallest difference, suggesting that the LLM has a stronger lead bias.

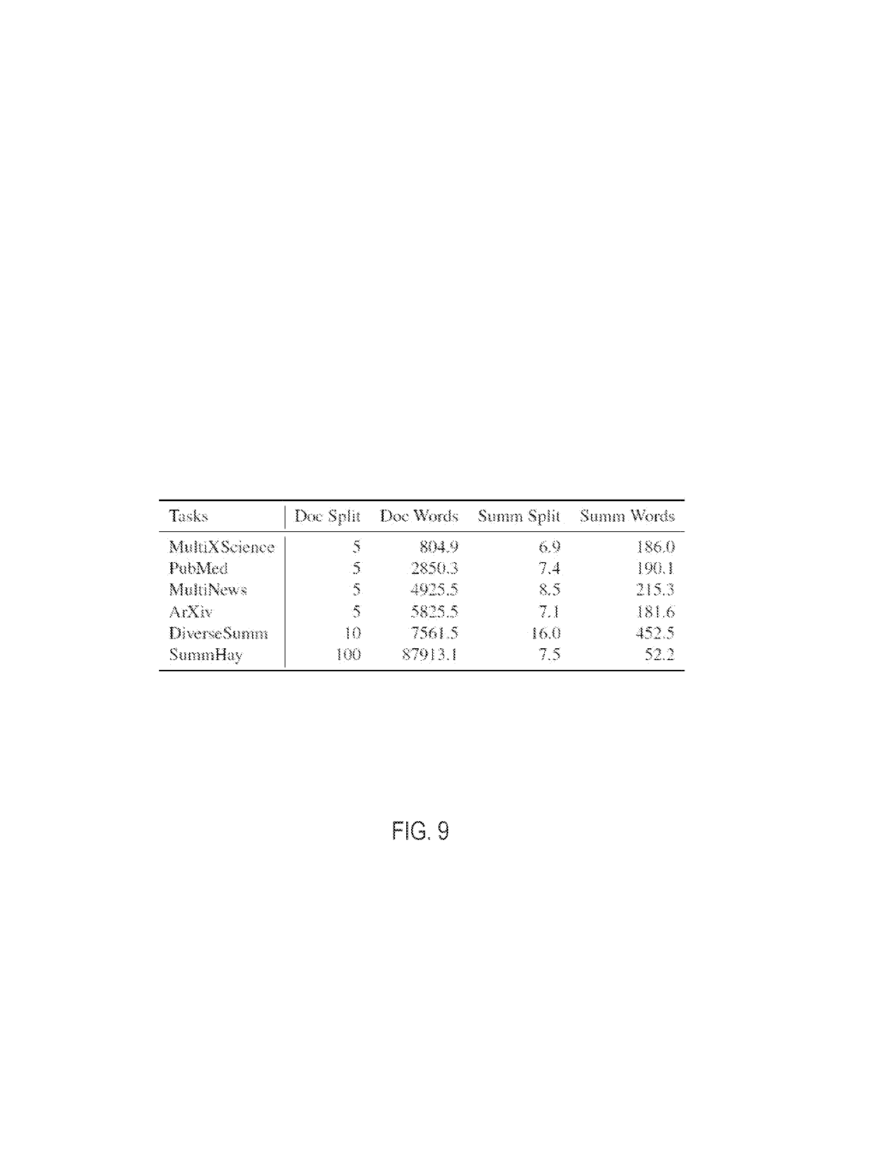

FIG. 9 illustrates statistics for the generated summaries on different tasks. the faithfulness analysis across different positions of documents. Experiments include two representative multidocument summarization datasets, MultiNews and MultiXScience; two long-form summarization datasets, ArXiv and PubMed; and two recent summarization datasets with extremely long contexts, DiverseSumm and SummHay. For ArXiv, PubMed, MultiNews, and MultiXScience, experiments randomly sampled 100 examples from the validation set, each consisting of five documents or sections. For DiverseSumm, experiments used all original 10 documents and randomly sample 100 examples.

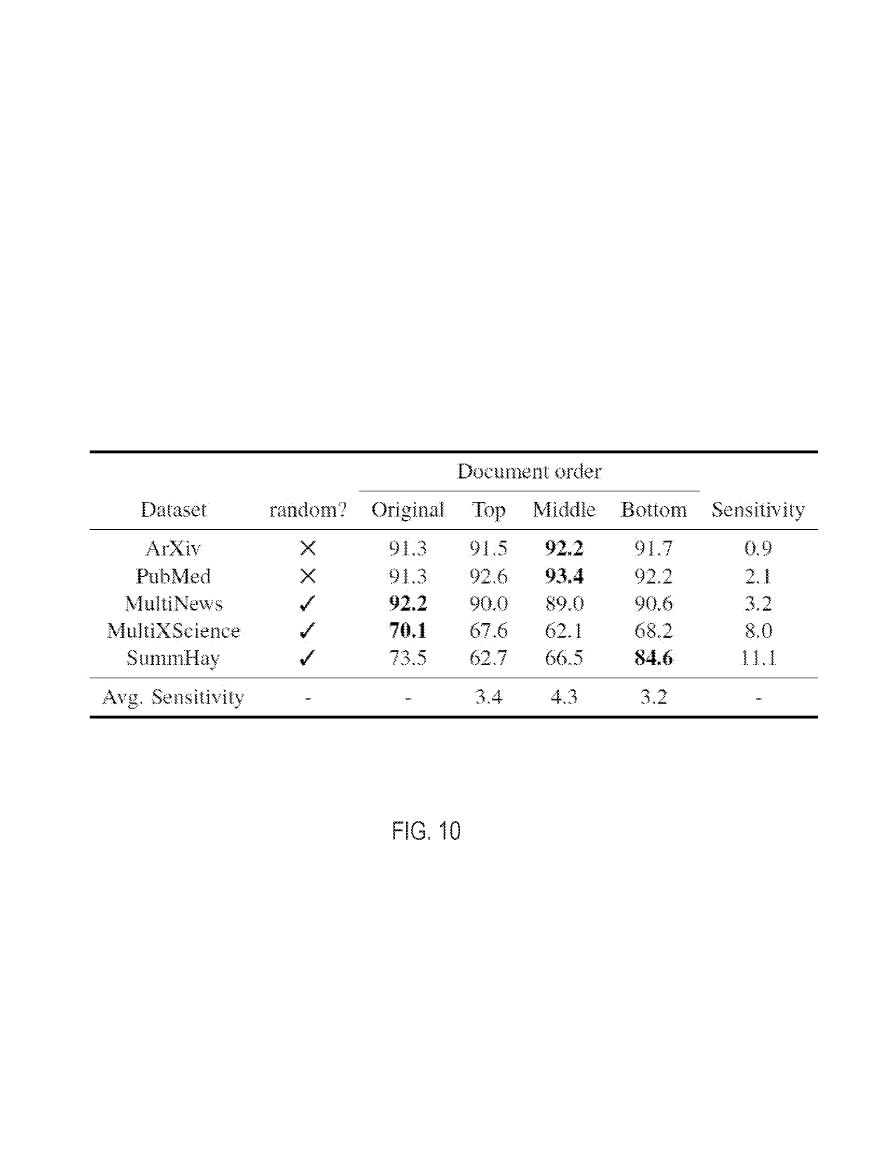

FIG. 10 illustrates the faithfulness score when perturbing the document order. The models generally generate the most faithful summaries either with the original order or when the most important document is placed at the front. When looking at the sensitivity across each ordering, the middle case has the highest sensitivity. Interestingly, the bottom ordering achieves a score 21.9 points over the top case for SummHay. This is attributed to how models handle long contexts, focusing towards the end when the context increases.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of configuring an artificial intelligence (AI) agent to respond to a user query based on retrieved contextual documents, comprising:
receiving, via a communication interface, the user query comprising a natural language description of a topic;
retrieving a plurality of documents related to the natural language description of the topic;
generating, by a first neural network based language model, a summary comprising a plurality of sentences from an input sequence of tokens concatenating the plurality of documents in an order;
determining for each sentence of the plurality of sentences, based on a first metric, a first document of the plurality of documents to which the sentence is attributed;
determining for each sentence, based on a second metric, whether each sentence is faithful to the document to which the sentence is attributed;
computing a set of faithfulness values corresponding to the plurality of documents, respectively, based on a percentage of sentences attributed to a respective document that are faithful to the respective document; and
selecting a document from the plurality of documents based on the set of faithfulness values for display via a user interface.

2. The method of claim 1, further comprising:
determining a positional bias metric based on differences between faithfulness values of the set of faithfulness values,
wherein the selected document is selected further based on the positional bias metric.

3. The method of claim 2, further comprising:
generating, by a second neural network based language model, a second summary comprising a second plurality of sentences from the input sequence of tokens;
determining a second positional bias metric associated with the second summary; and
using the second neural network based language model to perform a task based on a comparison of the positional bias metric to the second positional bias metric.

4. The method of claim 2, further comprising:
generating, by the first neural network based language model, a second summary comprising a second plurality of sentences from an input sequence of tokens concatenating the plurality of documents in a second order different from the order in response to the positional bias metric surpassing a threshold.

5. The method of claim 1, further comprising:
generating, by the first neural network based language model, a second summary comprising a second plurality of sentences from a second input sequence of tokens concatenating the plurality of documents in a second order different from the order; and
computing a second set of faithfulness values corresponding to the plurality of documents associated with the second summary,
wherein the selected document is selected further based on a comparison of the set of faithfulness values to the second set of faithfulness values.

6. The method of claim 5, wherein the selected document is selected based on the selected document having a highest average faithfulness value between the set of faithfulness values and the second set of faithfulness values.

7. The method of claim 1, wherein the retrieving the plurality of documents includes parsing internet content based on a search query.

8. A system for responding to a user query based on retrieved contextual documents, the system comprising:
a memory that stores an artificial intelligence (AI) agent including a first neural network based language model and a plurality of processor executable instructions;
a communication interface that receives the user query comprising a natural language description of a topic; and
one or more hardware processors that read and execute the plurality of processor-executable instructions from the memory, wherein the plurality of processor-executable instructions are configurable to cause the system to perform operations comprising:
retrieving a plurality of documents related to the natural language description of the topic;
generating, by the first neural network based language model, a summary comprising a plurality of sentences from an input sequence of tokens concatenating the plurality of documents in an order;
determining for each sentence of the plurality of sentences, based on a first metric, a first document of the plurality of documents to which the sentence is attributed;
determining for each sentence, based on a second metric, whether each sentence is faithful to the document to which the sentence is attributed;
computing a set of faithfulness values corresponding to the plurality of documents, respectively, based on a percentage of sentences attributed to a respective document that are faithful to the respective document; and
selecting a document from the plurality of documents based on the set of faithfulness values for display via a user interface.

9. The system of claim 8, wherein the plurality of processor-executable instructions are further configurable to cause the system to perform operations comprising:
determining a positional bias metric based on differences between faithfulness values of the set of faithfulness values,
wherein the selected document is selected further based on the positional bias metric.

10. The system of claim 9, wherein the plurality of processor-executable instructions are further configurable to cause the system to perform operations comprising:
generating, by a second neural network based language model, a second summary comprising a second plurality of sentences from the input sequence of tokens;
determining a second positional bias metric associated with the second summary; and
using the second neural network based language model to perform a task based on a comparison of the positional bias metric to the second positional bias metric.

11. The system of claim 9, wherein the plurality of processor-executable instructions are further configurable to cause the system to perform operations comprising:
generating, by the first neural network based language model, a second summary comprising a second plurality of sentences from an input sequence of tokens concatenating the plurality of documents in a second order different from the order in response to the positional bias metric surpassing a threshold.

12. The system of claim 8, wherein the plurality of processor-executable instructions are further configurable to cause the system to perform operations comprising:
generating, by the first neural network based language model, a second summary comprising a second plurality of sentences from a second input sequence of tokens concatenating the plurality of documents in a second order different from the order; and
computing a second set of faithfulness values corresponding to the plurality of documents associated with the second summary,
wherein the selected document is selected further based on a comparison of the set of faithfulness values to the second set of faithfulness values.

13. The system of claim 12, wherein the selected document is selected based on the selected document having a highest average faithfulness value between the set of faithfulness values and the second set of faithfulness values.

14. The system of claim 8, wherein the retrieving the plurality of documents includes parsing internet content based on a search query.

15. A non-transitory machine-readable medium comprising a plurality of instructions, executable by one or more processors, wherein the plurality of instructions are configurable to cause the one or more processors to perform operations comprising:
receiving, via a communication interface, a user query comprising a natural language description of a topic;
retrieving a plurality of documents related to the natural language description of the topic;
generating, by a first neural network based language model, a summary comprising a plurality of sentences from an input sequence of tokens concatenating the plurality of documents in an order;
determining for each sentence of the plurality of sentences, based on a first metric, a first document of the plurality of documents to which the sentence is attributed;
determining for each sentence, based on a second metric, whether each sentence is faithful to the document to which the sentence is attributed;
computing a set of faithfulness values corresponding to the plurality of documents, respectively, based on a percentage of sentences attributed to a respective document that are faithful to the respective document; and
selecting a document from the plurality of documents based on the set of faithfulness values for display via a user interface.

16. The non-transitory machine-readable medium of claim 15, wherein the plurality of instructions are further configurable to cause the one or more processors to perform operations comprising:
determining a positional bias metric based on differences between faithfulness values of the set of faithfulness values,
wherein the selected document is selected further based on the positional bias metric.

17. The non-transitory machine-readable medium of claim 16, wherein the plurality of instructions are further configurable to cause the one or more processors to perform operations comprising:
generating, by a second neural network based language model, a second summary comprising a second plurality of sentences from the input sequence of tokens;
determining a second positional bias metric associated with the second summary; and
using the second neural network based language model to perform a task based on a comparison of the positional bias metric to the second positional bias metric.

18. The non-transitory machine-readable medium of claim 16, wherein the plurality of instructions are further configurable to cause the one or more processors to perform operations comprising:
generating, by the first neural network based language model, a second summary comprising a second plurality of sentences from an input sequence of tokens concatenating the plurality of documents in a second order different from the order in response to the positional bias metric surpassing a threshold.

19. The non-transitory machine-readable medium of claim 15, wherein the plurality of instructions are further configurable to cause the one or more processors to perform operations comprising:
generating, by the first neural network based language model, a second summary comprising a second plurality of sentences from a second input sequence of tokens concatenating the plurality of documents in a second order different from the order; and
computing a second set of faithfulness values corresponding to the plurality of documents associated with the second summary,
wherein the selected document is selected further based on a comparison of the set of faithfulness values to the second set of faithfulness values.

20. The non-transitory machine-readable medium of claim 19, wherein the selected document is selected based on the selected document having a highest average faithfulness value between the set of faithfulness values and the second set of faithfulness values.
